(19) United States
(12) Patent Application Publication
(10) Pub. No.: US 2011/0297624 A1
(43) Pub. Date: Dec. 8, 2011

(54) SHOWERHEAD FILTER ASSEMBLY AND METHOD OF PURIFICATION

(75) Inventor: MATTHEW SMITH, Wooster, OH (US)

(73) Assignee: WAXMAN CONSUMER PRODUCTS GROUP INC., BEDFORD HEIGHTS, OH (US)

(21) Appl. No.: 13/150,468

(22) Filed: Jun. 1, 2011

Related U.S. Application Data
(60) Provisional application No. 61/350,615, filed on Jun. 2, 2010.

(51) Int. Cl. C02F 1/00; B01D 35/30; B01D 27/00

(52) U.S. Cl. 210/767; 210/446; 210/232

(57) ABSTRACT

A showerhead filter assembly and method for purifying fluid comprises a shower engine having an inner chamber, the inner chamber includes a fluid passage at a first end and an opening at a second end for receiving a filter assembly. The shower engine further comprises a faceplate comprising an outer opening in alignment with the opening at the second end of the inner chamber for receiving the filter assembly. The showerhead also comprises a filter assembly that includes a cartridge having a body, segmented opening at a first end and a cap at a second end. The filter assembly houses filter media to remove contaminates from fluid passing through the showerhead.

### CROSS REFERENCES TO RELATED APPLICATIONS

The following application claims priority to co-pending U.S. Provisional Patent Application Ser. No. 61/350,615 filed Jun. 2, 2010 entitled SHOWERHEAD FILTER ASSEMBLY AND METHOD OF PURIFICATION. The above-identified application is incorporated herein by reference in its entirety for all purposes.

### TECHNICAL FIELD

The present disclosure relates to a showerhead filter assembly and method of purification, and more specifically, a showerhead comprising a removable filter assembly and method of purifying fluid passing through the showerhead with the filter assembly.

### BACKGROUND

Both residential and commercial establishments typically include a stand-alone shower and/or a bathtub equipped with a showerhead for bathing. The showerheads are coupled to a water supply source. Two of the most common water supply sources include a well, typically in rural areas and water feed lines from a municipal water station or company. The showerheads can be fixed directly to the wall of the shower or bathtub, and more recently, can include a flexible hose or supply line allowing the user to position the showerhead at desired locations while bathing.

### SUMMARY

One example embodiment of the present disclosure includes a showerhead filter assembly for purifying fluid comprising a shower engine having inner and outer chambers. The inner chamber comprises a fluid passage at a first end and an opening at a second end for receiving a filter assembly. The inner chamber is partially enclosed by the outer chamber at the second end. The shower engine further comprises a faceplate coupled to the inner and outer chambers. The faceplate further comprises an outer opening in alignment with the opening at the second end of the inner chamber for receiving the filter assembly. The showerhead filter assembly further comprises a filter assembly comprising a cartridge having a body, segmented opening at a first end and removable cap at a second end, the filter assembly houses filter media to remove contaminates from fluid passing through the showerhead.

Another example embodiment of the present disclosure comprises a process of purifying fluid passing through a showerhead comprising inserting a filter cartridge having filter media between a fluid inlet and faceplate of the showerhead and removably securing the filter cartridge within a cylindrical chamber of the showerhead by rotating a threaded connection or a tab locking arrangement. The process further comprises passing fluid through the fluid inlet into the filter cartridge and filter media and removing contaminates from the fluid with the filter media. The process also comprises flowing filtered fluid from the filter cartridge out exit openings that correspond to openings in the cylindrical chamber and flowing filtered fluid from the cylindrical chamber out a faceplate of the showerhead.

Yet another example embodiment of the present disclosure comprises a showerhead filter assembly for purifying fluid comprising a showerhead having an inner chamber. The inner chamber comprises a fluid passage at a first end and an opening at a second end. The opening at the second end is for receiving a filter assembly. The filter assembly is removably located within the inner chamber and comprises a cartridge having first and second ends spaced by a body and filter media supported within the body, the filter media removes contaminates from fluid passing from the fluid passage to at least one exit opening in the showerhead.

Another example embodiment of the present disclosure comprises a process of purifying fluid passing through a showerhead comprising the steps of inserting a filter cartridge comprising filter media between a fluid inlet and faceplate of a showerhead. The process further comprises removably securing the filter cartridge within a cylindrical chamber of the showerhead by translating and rotating a tab locking arrangement, passing fluid through the fluid inlet into the filter cartridge and filter media, and removing contaminates from the fluid with the filter media. The process also comprises flowing filtered fluid from the filter cartridge out exit openings that correspond to entry openings in the cylindrical chamber, and flowing filtered fluid from the cylindrical chamber out a faceplate of the showerhead.

While another example embodiment of the present disclosure comprises a showerhead filter assembly for purifying fluid having a showerhead with a supply line connection and an inner chamber. The inner chamber comprises a fluid passage at a first end and an opening at a second end for receiving a filter assembly. The filter assembly comprises a cartridge having a body with first and second ends, a segmented diverter removably connected to the body at the first end and an end cap located at the second end. The filter assembly housing filter media within the body to remove contaminates from fluid passing through the showerhead. The showerhead further comprises a faceplate in fluid communication with the filter assembly. The faceplate has at least one exit opening for the passage of filtered fluid from the showerhead. The filter assembly is removably connected to the showerhead such that it can be installed and removed without disassembly of the showerhead.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 is a perspective exploded assembly view of a showerhead comprising a filter assembly constructed in accordance with one embodiment of the present disclosure;

FIG. 2 is a perspective assembled view of FIG. 1;

FIG. 3 is a perspective assembly view of a filter assembly constructed in accordance with one embodiment of the present disclosure;

FIG. 4 is a sectional perspective view of 3 along section lines 4-4;

FIG. 5 is a sectional view of FIG. 2 along section lines 5-5;

FIG. 6 is an exploded assembly view of a filter assembly constructed in accordance with one embodiment of the present disclosure;

FIG. 7 is an side elevation view of a showerhead constructed in accordance with one embodiment of the present disclosure;

FIG. 8 is a front elevation view of a showerhead constructed in accordance with one embodiment of the present disclosure;

FIG. 9 is a perspective assembly view of a showerhead comprising a filter assembly constructed in accordance with another embodiment of the present disclosure;

FIG. 10 is a side elevation sectional view of FIG. 9 along section lines 10-10;

FIG. 11 is a side elevation view of FIG. 9;

FIG. 12 is a perspective assembly view of FIG. 9;

FIG. 13 is a side elevation sectional assembly view of FIG. 12 along section lines 13-13;

FIG. 14 is a perspective exploded assembly view of a showerhead comprising a filter assembly constructed in accordance with another embodiment of the present disclosure;

FIG. 15 is a front elevation sectional assembly view of FIG. 14 along section lines 14-14;

FIG. 16 is a first side assembly elevation view of FIG. 14;

FIG. 17 is a sectional view of FIG. 16 along section lines 17-17;

FIG. 18 is a second side assembly elevation view of FIG. 14;

FIG. 19 is a sectional view of FIG. 18 along section lines 19-19; and

FIG. 20 is a process of purifying fluid passing through a fluid dispensing head in accordance with one embodiment of the present disclosure.

### DETAILED DESCRIPTION

Referring now to the figures generally wherein like numbered features shown therein refer to like elements throughout unless otherwise noted. The present disclosure relates to a showerhead filter assembly and method of purification, and more specifically, a showerhead comprising a removable filter assembly and process of purifying fluid passing through the showerhead with the filter assembly.

Both residential and commercial establishments typically include a stand-alone shower and/or a bathtub equipped with a showerhead for bathing. The establishments, as a result, require a fluid supply source provided most often from a municipality or well located on the respective property. The fluid supply provides in most instances, potable water (hereinafter referred to generally as “potable water”, “water”, or “fluid” interchangeably) of sufficient quality such that it can be consumed or used without immediate or long-term health risks.

However, even potable water in the U.S. may include various contaminates, such as bacteria, arsenic, metals, compounds, chlorine, and minerals mixed with carbon, (collectively or individually hereinafter “contaminates”). Accordingly, there is an interest to remove such contaminates from the water before use in bathing by the owner of a residential or commercial establishment. In particular, the interest extends to the removal of such contaminates in the water prior to the contact of the water on the body of the bather taking a shower, which is advantageously achieved through the present disclosure in the various showerhead filter assembly example embodiments discussed herein in combination with the referenced figures and claims.

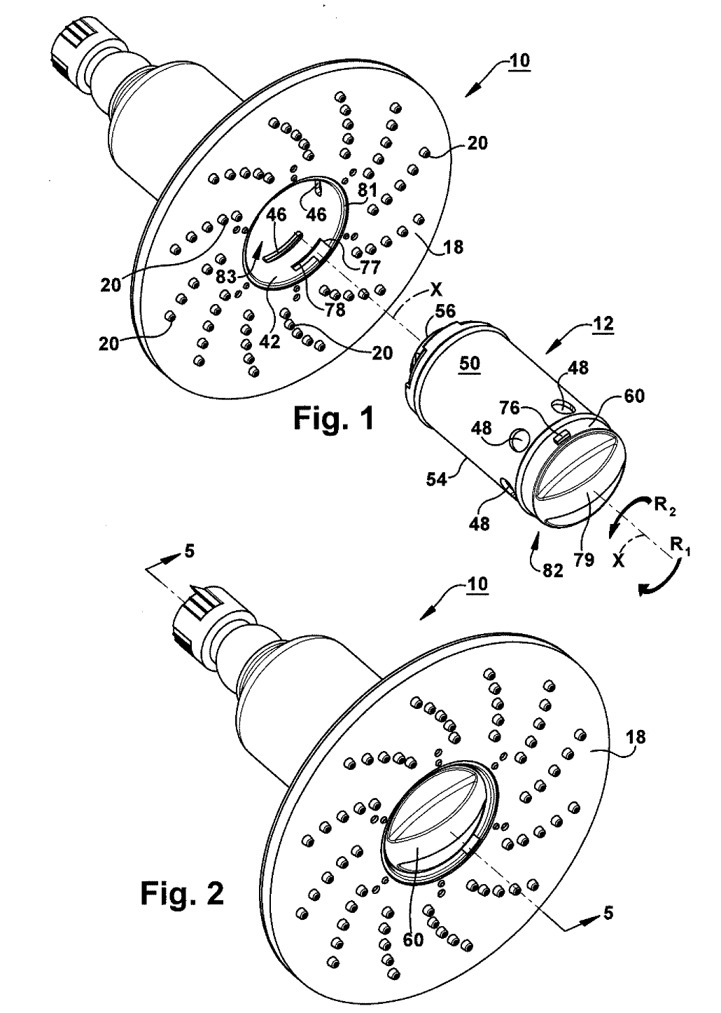

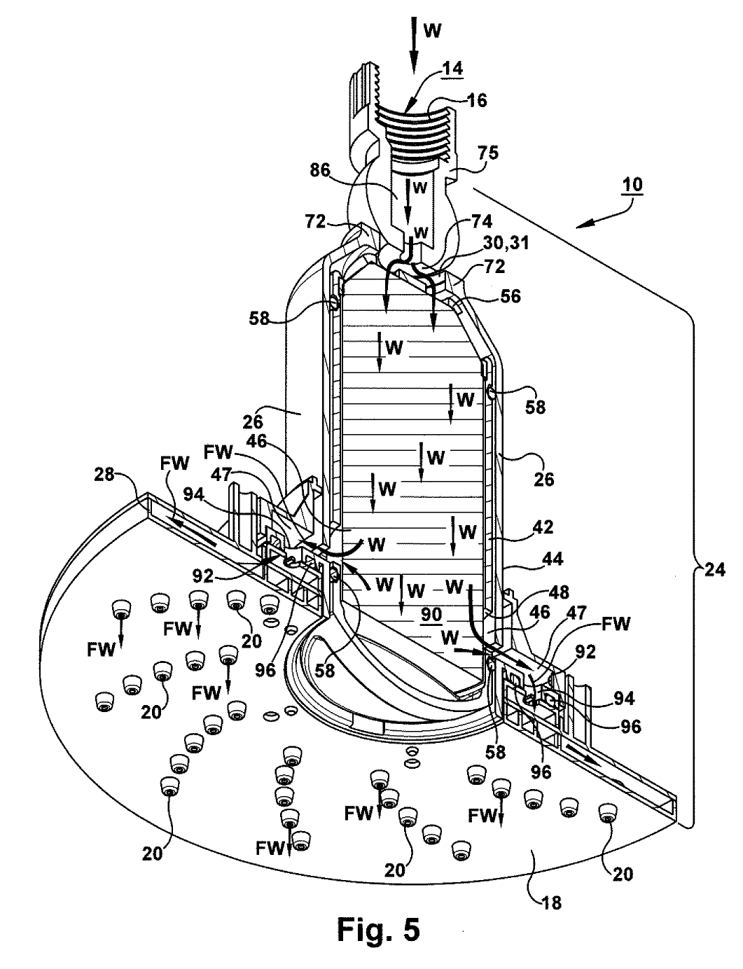

Referring now to the figures, and in particular to FIG. 1 is a perspective exploded assembly view of a showerhead 10 comprising a filter assembly 12 constructed in accordance with one example embodiment of the present disclosure. The showerhead 10 comprises an inlet 14 as best seen in the section view of FIG. 5 for attaching to a water supply from a residential or commercial establishment (not shown). The inlet 14 includes a plurality of threads 16 for connecting to a pipe or hose from the water supply, as can be appreciated by one skilled in the art.

Located at an end of the showerhead 10 opposite of the inlet 14 is a faceplate 18. The faceplate 18 (illustrated in FIG. 1) is annularly shaped, but could also be square, rectangular, or any other geometrical shape without departing from the spirit and scope of the present disclosure. The faceplate 18 includes a number of discharge apertures 20 that can be configured in an unlimited number of patterns, allowing for the exiting of water from the showerhead 10 as best seen in the pattern 22 of apertures 20 shown in FIG. 11.

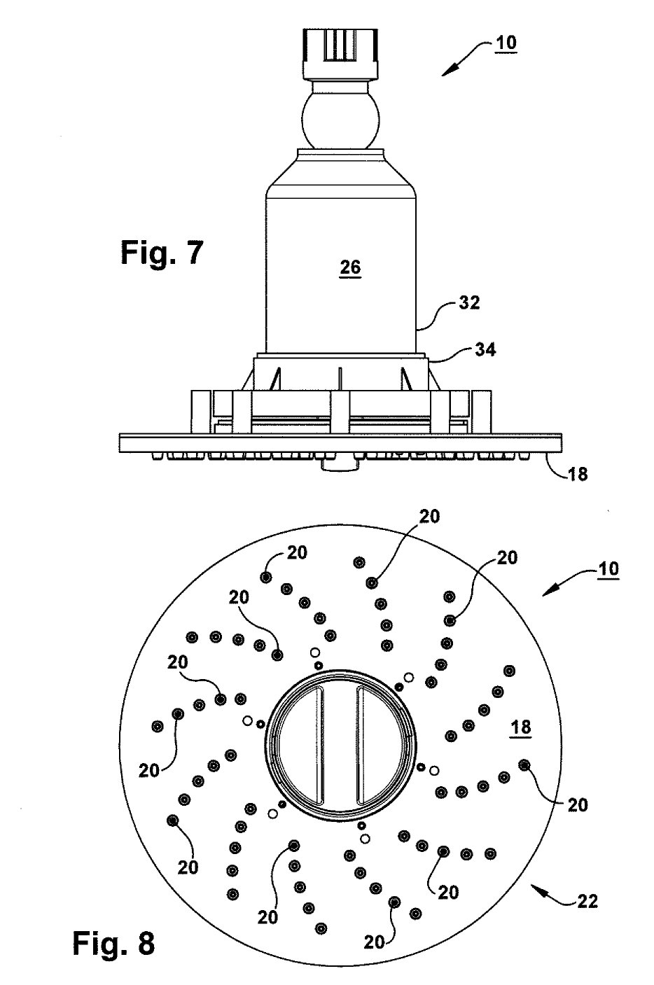

Located between the inlet 14 and faceplate 18 is a showerhead engine 24 (as shown in FIG. 5) that will be discussed below in further detail. Covering the showerhead engine 24 is a housing 26 that includes a first end 28 at the faceplate 18 that includes the openings in the discharge apertures 20 for the exiting of fluid from the faceplate. The housing further comprises a second end 30 having an opening 31 for the exposure and entry of fluid from the inlet 14. The housing 26 includes first and second members 32 and 34, respectively rotationally connected to the shower engine 24 as illustrated in the example embodiment of FIG. 7. The relative rotation of the first member 32 about the second member 34 changes the volumetric fluid flow rate or spray pattern exiting from the faceplate 18 of the showerhead 10.

The housing 26 is typically formed from plastic and can include any number of cavities or protuberances (not shown) about its annular perimeter to facilitate gripping and rotation of the members 32, 34 by the user of the showerhead 10. In an alternative example embodiment, the housing 26 further comprises a lever (not shown) to assist in the relative rotation of members 32, 34, and/or change the volumetric flow rate or spray pattern, exiting from the faceplate 18 of the showerhead 10.

Referring now to FIGS. 1, 5, and 7, the showerhead engine 24 comprises an inner cylindrical chamber 42 that is formed by an outer cylindrical wall 44. The cylindrical chamber 42 and outer wall 44 are best seen in the section view of FIG. 5. The inner cylindrical chamber 42 houses the filter assembly 12. The shower engine 24 is constructed of various plastic materials, but could equally be constructed of other materials without departing from the spirit and scope of the claimed disclosure.

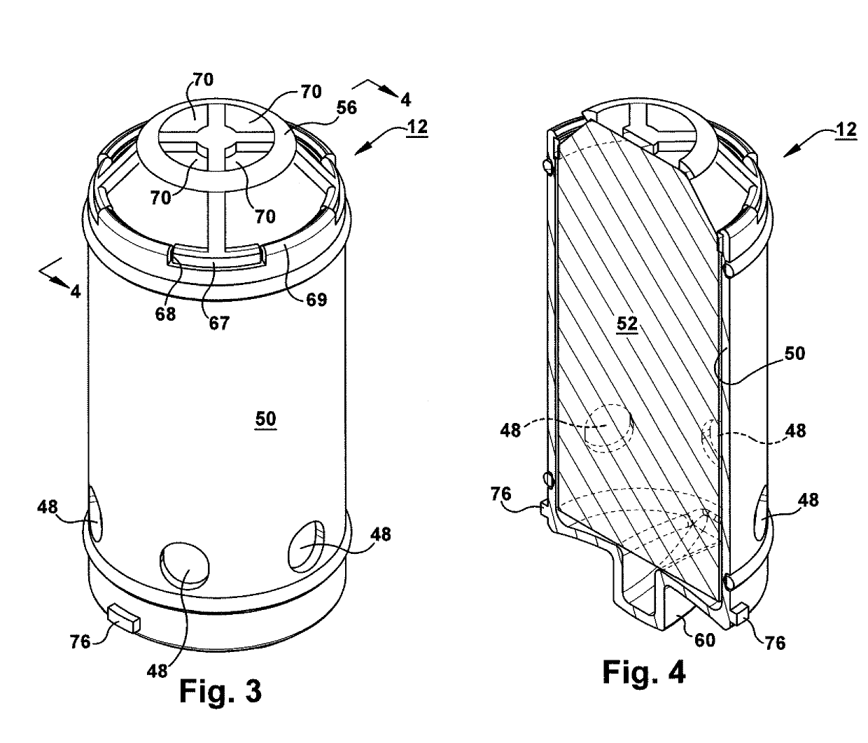

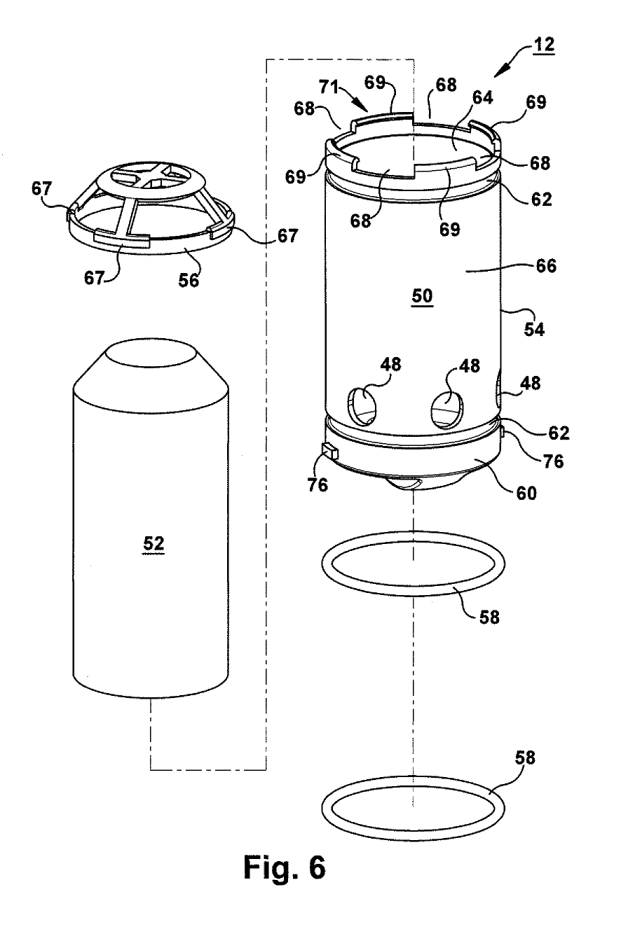

Annularly located around the perimeter of the inner cylindrical chamber 42 is a plurality of transition slots 46, allowing the passage of water to move from the filter assembly 12 into a peripheral region 47 of the showerhead engine 24. The passage of water moving in the filter assembly 12 exits through a plurality of openings 48 located in a filter cartridge housing 50 supporting internally filter media 52, as best seen in FIGS. 3 and 4. An exploded assembly view of a filter assembly 12 constructed in accordance with one exemplary embodiment of the present disclosure is shown in FIG. 6.

The filter assembly 12 is operably and removably positioned within the shower engine 24 of the showerhead 10 (see FIG. 1). Advantageously, the filter assembly 12 can be removed from the showerhead 10 without the need to disable the faceplate 18 or any part of the showerhead. This convenient construction allows users to quickly remove the filter media 52 by the interconnection of the showerhead 10 and filter assembly 12 without any tools.

The filter assembly 12 further comprises a body 54 having the openings 48 located therein, a diverter 56, upper and lower o-rings 58, and end cap 60. The upper and lower o-rings 58 surround the body 54 in a respective annulet or groove 62, forming a fluid-tight sealing connection between the body and inner chamber 42 of the showerhead engine 24. The end cap 60 in one example embodiment is molded into the body 54. In another example embodiment, the end cap 60 and/or diverter 56 include an outer or inner surface that form a press-fit type connection with an inner 64 or an outer 66 surface, respectively of the body 54.

One or more plurality of openings 48 of the filter assembly 12 are reassured alignment with one or more transition slots 46 (see FIG. 1) as a result of the number and/or geometrical configuration of the slot and openings. This in turn allows the fluid or water to pass from the cartridge assembly 12 to the peripheral region 47 while maintaining the water that exits the openings 48 between the upper and lower o-rings 58 in the inner cylinder chamber 42.

In the illustrated example embodiment of FIG. 6, the diverter 56 is removable from the body 54, allowing for the removal and insertion of filter media 52. The diverter 56 attaches to the filter cartridge housing 50 through a plurality of arms 67 that are snap fit into corresponding slots 68. In an alternative example embodiment, the arms 67 nest under rails 69 forming the slots 68 when the diverter and body 54 are relatively rotated, forming a rotatable connection. When the diverter 56 is removed from the filter cartridge housing 50, an opening 71 is formed as shown in FIG. 6. The opening 71 allows the filter media 52 to be inserted or removed from the cartridge 50.

The diverter 56 is segmented into four equally shaped opening segments 70, as best seen in FIG. 3 that disperse the water or fluid (represented by reference characters “W” in FIG. 5) as it enters the inner surface 64 of the housing 50 and filter media 52. The opening segments 70 are positioned within the inner chamber 42 and engage an abutment 72 of the inner chamber. The abutment 72 annularly extends inwardly from the inner chamber 42 and includes a fluid passage 74 centrally located therein (see FIG. 5) from the inlet 14 of a securing fixture 75.

The filter media 52 can be replaced with new media by removing the diverter 56 from the body 54 and pulling the media from the filter assembly 12. In one example embodiment, the filter media 52 is a porous material that includes granulated carbon. In yet another example embodiment, the filter media 52 comprises a KDF filter comprising copper and zinc alloy particles manufactured by KDF Fluid Treatment Inc. of Three Rivers, Mich. In the illustrated example embodiment of FIG. 6, the filter media is a screen covered KDF filtered material with granulated carbon. The filer media comprising KDF material expands the identified contaminates

As entry water W passes from the inlet 14 into the filter assembly 12 and more specifically filter media 52. The filter media 52 traps contaminates within the filter media, while allowing only relatively cleaner water “FW” to exit the filter media and filter assembly 12 into the peripheral region 47, ultimately exiting the showerhead 10.

In the illustrated example embodiment, the filter body 54, diverter 56, and end cap 60 are made from plastic. In the illustrated embodiment of FIG. 6, the o-rings 58 are made from rubber and/or neoprene.

As stated above and indicated by FIGS. 3 and 4, the filter assembly 12 is inserted and removed from the showerhead 10 by moving the filter assembly through an opening 81 in the faceplate 18 that corresponds in an opening 83 in the inner chamber 42 (see FIG. 1). In one example embodiment, the filter assembly 12 is securely seated in the inner chamber 42 by the combined insertion and rotation of the cartridge 50, engaging a threaded assembly formed by male and female thread on the cartridge assembly and inner chamber 42.

In an alternative example embodiment, the connection is between the showerhead engine 24 and filter assembly 12 is achieved by a locking arrangement 82 (see FIG. 1). The locking arrangement 82 comprises two or more tabs 76 projecting from the filter cartridge housing 50, and more specifically the end cap 60. The locking arrangement 82 further comprising first and second slots 77, 78, respectively located in the wall of the inner cylindrical chamber 42 (see FIG. 1) that correspond to receive an associated tab of tabs 76. Each tab of tabs 76 is inserted into the first slot 77 by axially translating the filter assembly 12 along axis X of FIG. 1 into the inner chamber 42 then rotating the filter assembly in the direction of R1 (locking direction) to lock the filter assembly into the showerhead 10. The filter assembly 12 is conveniently rotated for insertion and removal from the showerhead by a handle 79 located and formed into the end cap 60.

The locking arrangement 82 advantageously requires in the illustrated example embodiment of FIG. 1 just a quarter of turn in the locking direction R1 for engagement of the tabs 76 with the second slot 78, preventing removal of the filter assembly 12 from the showerhead 10 without rotation of the filter assembly in the unlocking R2 direction. In another example embodiment, the cartridge 50 engages the inner chamber 42 by a snap-ring or detent type connection. In yet another example embodiment, the faceplate 18 is circular and the filter assembly 12 is symmetrically positioned within the faceplate 18 and inner chamber 42.

During operation, the water W from a water supply enters the inlet 14, passing through cavity 86 and fluid passage 74 of the inner chamber 42. Upon entry to the inner chamber 42, the water engages and is separated by the segments 70 of the diverter 56, exciting the water as it enters the filter media 52. While in the filter media 52, the water is cleansed from contaminates as it moves downward in the direction of the arrows illustrated in FIG. 5. The water W within the filter media 52 may continue to the proximal end 90 until a sufficient volume or pressure is achieved, which results in the discharge of the water from the cartridge 50 openings 48 into the corresponding flow slot 46, allowing the passage of filtered water FW into the peripheral region 47 of the showerhead engine 24.

As the filtered water FW flows downward and annularly within the peripheral region 47, as indicated by the direction of the arrows in FIG. 5, it passes annularly through a spay adjustment member 92. The spray adjustment member 92 alters the volumetric flow rate and/or spray pattern of the water entering the faceplate 18. Once the water passes through the spray adjustment member 92, it enters the faceplate 18 and exits through the pattern 22 of apertures 20 of the showerhead 10.

The filtered water FW passes through channels 94 in the spray adjustment member 92 that allows for the relative rotation of the upper and the lower members 32, 34, respectively over inner and outer o-rings 96. The inner and outer o-rings 96 contain the filtered water FW within the spray adjustment member 96 while providing for the relative rotation between lower and upper members 32, 34.

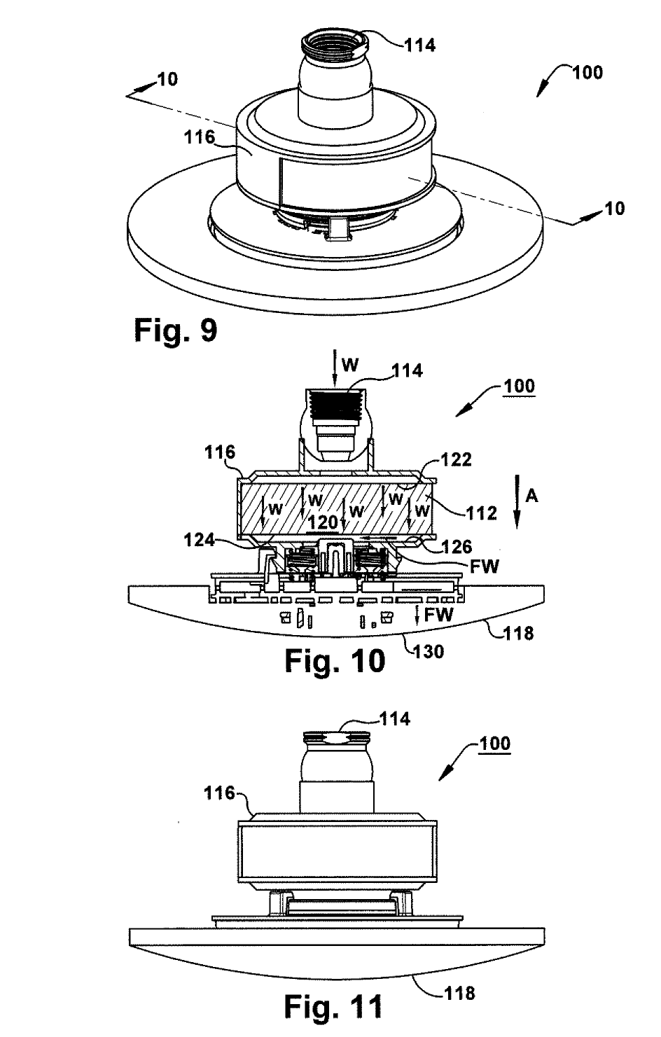

Referring now to FIGS. 9-13 is another example embodiment of a showerhead 100 comprising a side-loaded filter assembly 112. The showerhead 100 includes an inlet 114 for attachment to a water supply for the feeding of water to the showerhead. A cylindrical chamber 116 houses the filter assembly 112 that includes filter media 120, which operates the same to filter contaminates from the water into a filter media as the embodiment of FIG. 5 other than the differences in geometrical configuration. Advantageously, the filter assembly 112 can be removed from the showerhead 100 without the need to disable the faceplate 118 or any part of the showerhead. This convenient construction allows users to quickly remove the filter media 120 by the interconnection of the showerhead 100 and filter assembly 112 without any tools.

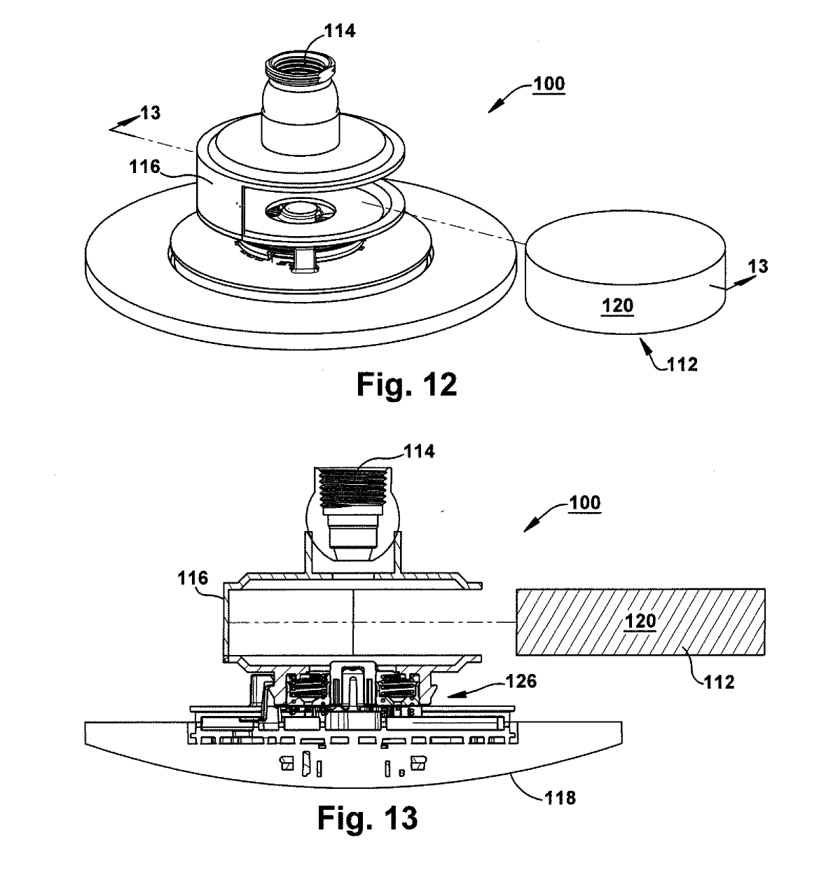

In one example embodiment, the filter media 120 is a porous material that includes granulated carbon. In yet another example embodiment, the filter media 120 comprises a KDF filter comprising copper and zinc alloy particles manufactured by KDF Fluid Treatment Inc. of Three Rivers, Mich. In the illustrated example embodiment of FIG. 12, the filter media 120 is a screen covered KDF filtered material with granulated carbon.

Entry water W passes from the inlet 114 into an upper region 122 of filter assembly 112 before entering into filter media 120. The filter media 120 traps contaminates within the filter media as it proceed to a lower region 124, as illustrated in FIG. 10. Relatively cleaner water “FW” then exits the filter media 120 at the lower region 124 into a channel system 126 before exiting the showerhead 100 through discharge apertures 130 in the manner similarly described.

The water flowing through the showerhead 100 passes through the cylindrical chamber 116 and filter media 120 in the direction of arrow “A” shown in FIG. 10 and into and out of the faceplate 118. In one example embodiment, the filter assembly 112 comprises an outer cartridge similarly constructed as the cartridge 50.

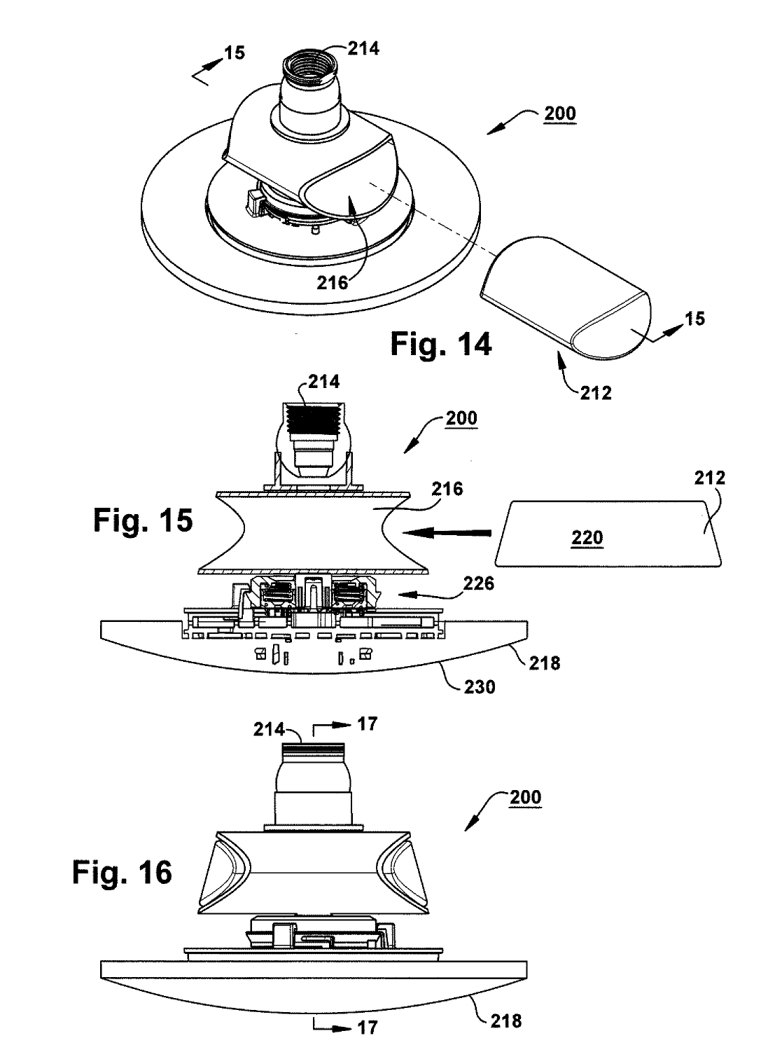

Referring now to FIGS. 14-19 is another example embodiment of a showerhead 200 comprising an oval-shaped filter assembly 212. The showerhead 200 includes an inlet 214 for attachment to a water supply for the feeding of water to the showerhead. An oval chamber 216 houses the filter assembly 212 that includes filter media 220, which and operates the same to filter contaminates from the water into a filter media as the embodiment of FIG. 5 other than the differences in geometrical configuration. Advantageously, the filter assembly 212 can be removed from the showerhead 200 without the need to disable the faceplate 218 or any part of the showerhead. This convenient construction allows users to quickly remove the filter media 220 by the interconnection of the showerhead 200 and filter assembly 212 without any tools.

In one example embodiment, the filter media 220 is a porous material that includes granulated carbon. In yet another example embodiment, the filter media 220 comprises a KDF® filter comprising copper and zinc alloy particles manufactured by KDF Fluid Treatment Inc. of Three Rivers, Mich. In the illustrated example embodiment of FIG. 15, the filter media 220 is a screen covered KDF filtered material with granulated carbon.

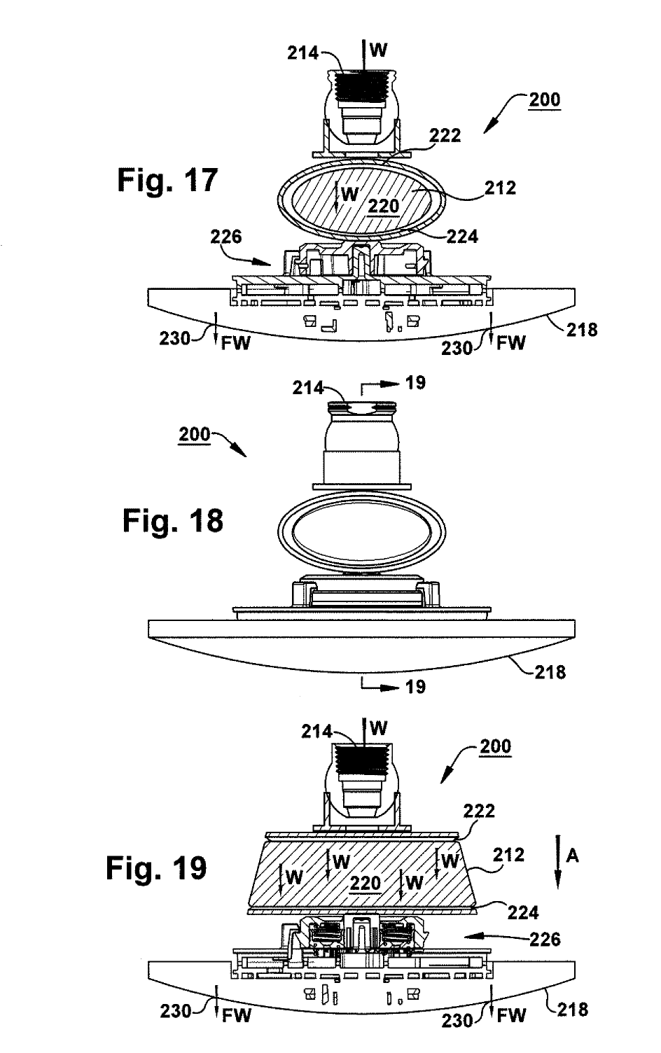

Entry water W passes from the inlet 214 into an upper region 222 of filter assembly 212 before entering into filter media 220. The filter media 220 traps contaminates within the filter media as it proceed to a lower region 224, as illustrated in FIGS. 17 and 19. Relatively cleaner water “FW” then exits the filter media 220 at the lower region 224 into a channel system 226 before exiting the showerhead 200 through discharge apertures 230 in the manner similarly described.

The water flowing through the showerhead 200 passes through the cylindrical chamber 216 and filter media 220 in the direction of arrow “A” shown in FIG. 19 and into and out of the faceplate 218. In one example embodiment, the filter assembly 212 comprises an outer cartridge similarly constructed as the cartridge 50.

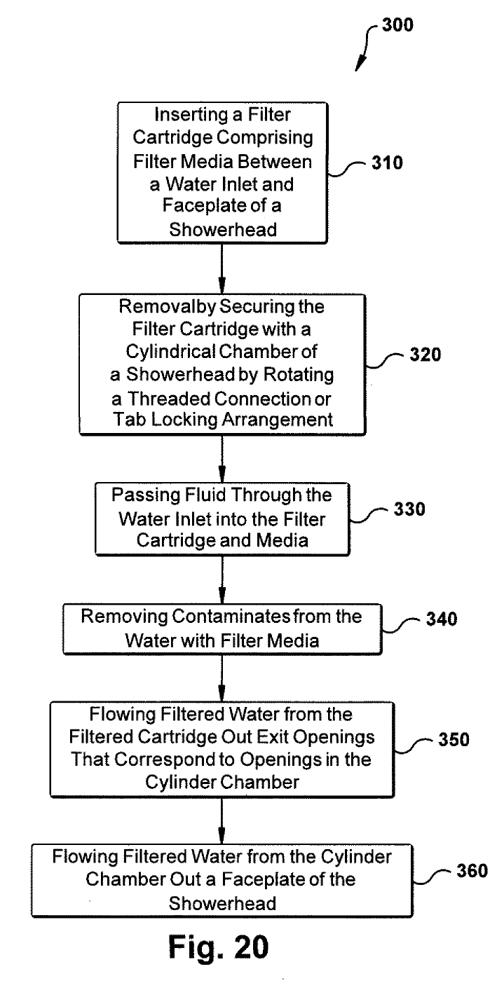

Referring now to FIG. 20 is a process 300 of purifying fluid passing through a fluid dispensing head in accordance with one embodiment of the present disclosure. At 310, the process 300 comprises inserting a filter cartridge comprising filter media between a water inlet and faceplate of a showerhead. At 320, the process 300 comprises removably securing the filter cartridge within a cylindrical chamber of a showerhead by rotating a threaded connection or a tab locking arrangement. At 330, the process 300 comprises passing fluid through the water inlet into the filter cartridge and media. At 340, the process 300 comprises removing contaminates from the water with the filter media. At 350, the process 300 comprises flowing filtered water from the filter cartridge out exit openings that correspond to openings in the cylindrical chamber. At 360, the process 300 comprises flowing filtered water from the cylindrical chamber out a faceplate of a showerhead.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A showerhead filter assembly for purifying fluid comprising:
a showerhead having an inner chamber, the inner chamber comprising a fluid passage at a first end and an opening at a second end, the opening at the second end for receiving a filter assembly;
the filter assembly is removably located within the inner chamber comprising a cartridge having first and second ends spaced by a body and filter media supported within said body, the filter media removing contaminates from fluid passing from the fluid passage to at least one exit opening in the showerhead.

2. The showerhead filter assembly of claim 1 wherein said filter assembly and inner chamber are cylindrically shaped.

3. The showerhead filter assembly of claim 1 wherein said filter assembly and inner chamber are ovally shaped.

4. The showerhead filter assembly of claim 2 wherein said showerhead further comprises a faceplate, said faceplate including a portion of said opening and inner chamber for receiving said filter assembly such that the filter assembly can be removed or installed without disassembling any parts of the showerhead.

5. The showerhead filter assembly of claim 2 wherein said showerhead further comprises a faceplate, said inner chamber and opening for receiving said filter assembly being located between a fluid supply connection and said faceplate.

6. The showerhead filter assembly of claim 1 wherein said filter assembly further comprises a top cap removably located in said first end of said body and a bottom cap molded into said body at said second end.

7. The showerhead filter assembly of claim 6 wherein said top cap further comprises a diverter formed from a plurality of opening segments for diverting fluid received from said fluid passage as it passes into the filter media of said filter assembly.

8. The showerhead filter assembly of claim 1 wherein said body further comprises a plurality of openings for passing filtered fluid from said filter media into said inner chamber.

9. The showerhead filter assembly of claim 8 wherein said inner chamber further comprises a plurality transition slots for receiving filtered fluid from the inner chamber and providing passage for the filtered fluid into a peripheral region of the showerhead, the peripheral region being in fluid communication with a faceplate coupled to the showerhead, the faceplate having at least one exit opening for the passage of filtered fluid from the showerhead.

10. The showerhead of claim 9 wherein said filter assembly further comprises first and second O-rings surrounding an external surface of said body, the first o-ring being positioned on said external surface above said plurality of openings and the second o-ring being positioned on said external surface below said plurality of openings, the o-rings providing a sealing engagement with said inner chamber and filtered assembly such that said filtered water during use remains between said first and second o-ring in the inner chamber as the filtered fluid passes from the plurality of openings to the peripheral regions through said transition slots.

11. A process of purifying fluid passing through a showerhead comprising the steps of
inserting a filter cartridge comprising filter media between a fluid inlet and faceplate of a showerhead;
removably securing the filter cartridge within a cylindrical chamber of the showerhead by translating and rotating a tab locking arrangement;
passing fluid through the fluid inlet into the filter cartridge and filter media;
removing contaminates from the fluid with the filter media;
flowing filtered fluid from the filter cartridge out exit openings that correspond to entry openings in the cylindrical chamber; and
flowing filtered fluid from the cylindrical chamber out a faceplate of the showerhead.

12. The method of claim 11 further comprising inserting said filter media through said faceplate.

13. The method of claim 11 further comprising replacing filter media in said filter cartridge by removing a cap removably connected to said filter cartridge allowing for the filter media to exit an inner housing of the cartridge.

14. The method of claim 11 further comprising isolating filtered fluid within said cylindrical chamber as it passes from the filter cartridge through said exit openings and into said entry openings in the cylindrical chamber.

15. The method of claim 11 wherein said isolating is achieved by positioning first and second o-ring along an external surface of said filter cartridge spacially about said exit openings in said filter cartridge and entry openings in said cylindrical chamber.

16. A showerhead filter assembly for purifying fluid comprising:
a showerhead having a supply line connection and an inner chamber, the inner chamber comprising a fluid passage at a first end and an opening at a second end for receiving a filter assembly;
the filter assembly comprising a cartridge having a body having first and second ends, a segmented diverter removably connected to said body at said first end and an end cap located at said second end, the filter assembly housing filter media within said body to remove contaminates from fluid passing through said showerhead;
the showerhead further comprising a faceplate in fluid communication with said filter assembly, the faceplate having at least one exit opening for the passage of filtered fluid from said showerhead, said filter assembly removably connected to said showerhead such that it can be installed and removed without disassembly of the showerhead.

17. The showerhead filter assembly of claim 16 further comprising a locking arrangement for securing said filter assembly into said inner chamber, the locking arrangement comprising a plurality of tabs surrounding an external surface of said body of said filter assembly and corresponding slots for receiving said tabs located within said inner chamber.

18. The showerhead filter assembly of claim 16 wherein said filter assembly and inner chamber are cylindrically shaped.

19. The showerhead filter assembly of claim 16 wherein said filter assembly and inner chamber are ovally shaped.

20. The showerhead filter assembly of claim 18 wherein said faceplate includes a portion of said opening and inner chamber for receiving said filter assembly.
